(19) United States
(12) Patent Application Publication
(10) Pub. No.: US 2025/0158843 A1
(43) Pub. Date: May 15, 2025

(54) MULTICAST SERVICE FILTER RULE TRANSFORMATION METHOD AND APPARATUS

(71) Applicant: SYSMATE CO., LTD., Daejeon (KR)

(72) Inventors: Huijin JANG, Daejeon (KR); Jaegu YOO, Daejeon (KR); Junsung KIM, Daejeon (KR); Ganho CHOI, Daejeon (KR)

(73) Assignee: SYSMATE CO., LTD., Daejeon (KR)

(21) Appl. No.: 18/525,678

(22) Filed: Nov. 30, 2023

(30) Foreign Application Priority Data
Nov. 14, 2023 (KR) 10-2023-0157157

(51) Int. Cl. H04L 12/18

(52) U.S. Cl. CPC H04L 12/18

(57) ABSTRACT

Disclosed are a multicast service filter rule transformation method and apparatus. A multicast service filter rule transformation method according to an embodiment includes receiving a unicast filter table, transforming the received unicast filter table into a plurality of multicast service filter tables by dividing rule entries of the unicast filter table, and generating a multicast egress port that matches each filter rule in the multicast service filter tables.

### CROSS-REFERENCE TO RELATED APPLICATION(S)

This application claims the benefit under 35 USC § 119(a) of Korean Patent Application No. 10-2023-0157157, filed on Nov. 14, 2023, in the Korean Intellectual Property Office, the entire disclosure of which is incorporated herein by reference for all purposes.

### BACKGROUND

### 1. Field

The present invention relates to flow transmission and rule transformation technology for flow transmission.

### 2. Description of Related Art

Unicast is a one-to-one communication method. A unicast source transmits various data to different user equipment (UE) through network devices. For example, the unicast source transmits five different pieces of data to UE 1, UE 2, UE 3, UE 4, and UE 5, respectively. Unicast communication allows different data to be delivered to different users.

Multicast refers to transmitting the same flow to authorized user equipment. For example, in multicast, the same data is simultaneously transmitted to authorized UE 6, UE 7, and UE 8. Multicast is particularly suitable for scenarios like online video conferencing, online on-demand video, and other applications. In multicast, data can be transmitted to all target nodes at once, or to specific entities (authorized UEs) only.

Network devices operate according to predefined service flow rules to process service flows. Each service flow rule consists of a set of fields, including a matching field that matches headers, an action field that defines processing content, and a statistical information (stats) field.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

According to one embodiment, for multicast transmission of a service flow, a multicast service filter rule transformation method and apparatus for transforming a unicast filter table into a multicast service filter table are proposed.

A multicast service filter rule transformation method according to an embodiment includes receiving a unicast filter table, transforming the received unicast filter table into a plurality of multicast service filter tables by dividing rule entries of the unicast filter table, and generating a multicast egress port that matches each filter rule in the multicast service filter tables.

The transforming into the multicast service filter tables may include setting a service filter table ID by dividing the rule entries constituting the unicast filter table into the plurality of multicast service filter tables, setting an ingress label for each ingress port in the multicast service filter tables according to a bridge domain connected to the multicast service filter table and an egress port, and generating an egress label that matches the ingress label.

The setting of the ingress label may include calculating a value of the multicast service filter table using a value N of the service filter table ID, and calculating a value of the ingress label using values of multicast service filter tables connected to the ingress port.

In the calculating of the value of the multicast service filter table, the value N of the service filter table ID may be processed as 2N to calculate the value of the multicast service filter table.

In the calculating of the value of the ingress label, the value of the ingress label may be calculated by performing a bitwise OR operation on the values of the multicast service filter tables connected to the ingress port.

In the generating of the egress label, the number of multicast egress port group IDs (multicast group IDs, hereinafter referred to as “MGIDs”) may be calculated by performing an intersection operation algorithm on service filters, the number of SF tables may align with the total number N of egress ports, and the number of MGIDs, which may be determined by the number of cases of multicast based on N egress ports, may be a maximum of 2N.

In the generating of the multicast egress port, a bitwise OR operation may be performed on each value of the egress label to generate the multicast egress port that matches the bitwise OR-ed egress label.

The multicast service filter rule transformation method may further include selectively applying an ingress port to the filter rule in the multicast service filter table matching the ingress port based on the multicast service filter table.

A multicast service filter rule transformation apparatus according to another embodiment includes a processor and a memory configured to load a computer program executed by the processor, wherein the processor receives a unicast filter table, transforms the received unicast filter table into a plurality of multicast service filter tables by dividing rules entries of the unicast filter table, and generates a multicast egress port that matches each filter rule in the multicast service filter tables.

Other features and aspects will be apparent from the following detailed description, the drawings, and the claims.

### BRIEF DESCRIPTION OF THE DRAWINGS

FIG. 1 is a flowchart illustrating a multicast rule transformation method according to an embodiment of the present invention.

FIG. 2 is a diagram illustrating the concept of transformation from unicast service flow rules into multicast service flow rules according to an embodiment of the present invention.

FIG. 3 is a diagram illustrating a bridge domain for generating an ingress label according to an embodiment of the present invention.

FIG. 4 is a diagram illustrating a bridge domain for generating an ingress label according to another embodiment of the present invention.

FIG. 5 is a diagram illustrating an example of calculating the number of multicast egress port group IDs according to an embodiment of the present invention.

FIG. 6 is a diagram illustrating an example of multicast output using a multicast service filter table according to an embodiment of the present invention.

FIG. 7 is a diagram illustrating the hardware configuration of a multicast service filter rule transformation apparatus according to an embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The advantages and features of the present invention and the manner of achieving the advantages and features will become apparent with reference to embodiments described in detail below together with the accompanying drawings. However, the present invention may be implemented in many different forms and should not be construed as being limited to the embodiments set forth herein, and the embodiments are provided such that this disclosure will be thorough and complete and will fully convey the scope of the present invention to those skilled in the art, and the present invention is defined only by the scope of the appended claims. The same reference numerals refer to the same components throughout this disclosure.

In the following description of the embodiments of the present invention, if a detailed description of related known functions or configurations is determined to unnecessarily obscure the gist of the present invention, the detailed description thereof will be omitted herein. The terms described below are defined in consideration of the functions in the embodiments of the present invention, and these terms may be varied according to the intent or custom of a user or an operator. Therefore, the definitions of the terms used herein should follow contexts disclosed herein.

Hereinafter, embodiments of the present invention will be described in detail with reference to the accompanying drawings. However, the present invention may be realized in various forms, and the scope of the present invention is not limited to such embodiments. The embodiments of the present invention are provided to aid those skilled in the art in the explanation and the understanding of the present invention.

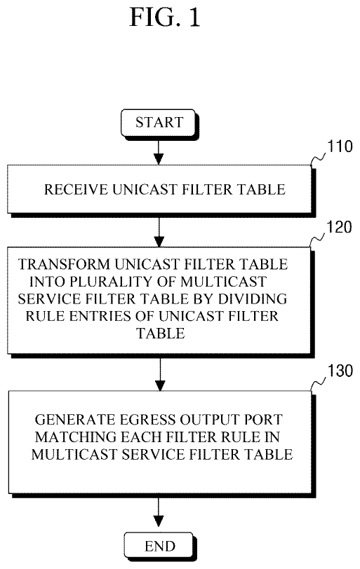

FIG. 1 is a flowchart illustrating a multicast rule transformation method according to an embodiment of the present invention.

Referring to FIG. 1, a multicast service filter rule transformation apparatus generates a multicast egress port by performing rule labeling conversion on a user-described unicast filter table into a multicast service filter table for multicast transmission of a service flow. The multicast service filter rule transformation apparatus may be a network device such as a router or a switch. Through this process, the multicast service filter rule transformation device can multicast unicast service flows to multiple ports based on matching conditions determined by rule matching.

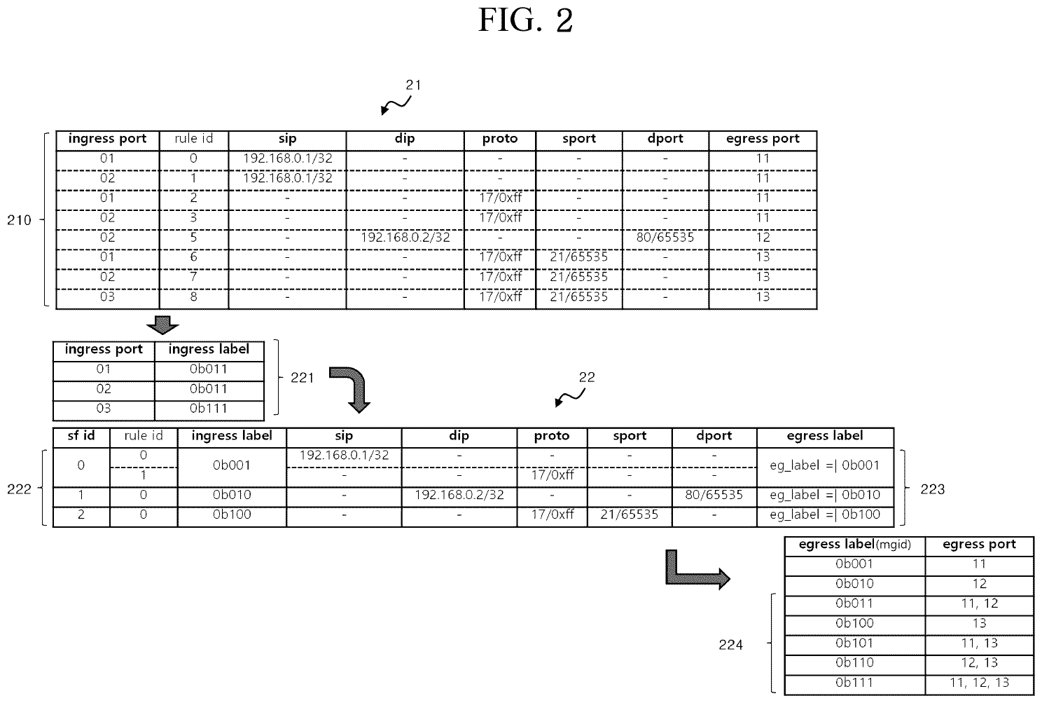

More specifically, the multicast service filter rule transformation apparatus receives a unicast filter table (110). An example of the unicast filter table will be described below with reference to FIG. 2.

Next, the multicast service filter rule transformation apparatus transforms the unicast filter table into a plurality of multicast service filter (SF) tables by dividing rule entries of the received unicast filter table (120). An example of the multicast SF table will be described below with reference to FIG. 2.

In the transforming into the multicast SF table (120), the multicast service filter rule transformation apparatus sets a service filter table ID for each multicast SF table by dividing the rule entries constituting the unicast filter table into the plurality of multicast SF tables.

Subsequently, the multicast service filter rule transformation apparatus, according to the multicast SF table and a bridge domain (BD) connected to the egress port, sets the ingress label for each ingress port in the multicast service filter table.

In the setting of the ingress label, the multicast service filter rule transformation apparatus may calculate a value of the ingress label by performing a bitwise OR operation on a value of the multicast SF table connected to the ingress port.

Subsequently, the multicast service filter rule transformation apparatus matches the egress label to the multicast SF table to generate an egress label.

Examples of multicast SF table ID setting, ingress label setting, and egress label setting will be described below with reference to FIG. 2.

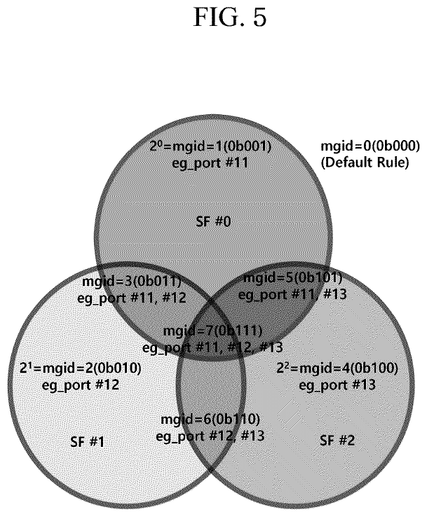

In the generating of the egress label, the multicast service filter rule transformation apparatus may calculate the number of multicast egress port group IDs (multicast group IDs, hereinafter referred to as “MGIDs”) by performing an intersection operation algorithm among multicast SFs. At this time, the number of SF tables corresponds to the total number N of egress ports, and the number of MGIDs, which may be determined by the number of cases of multicast based on N egress ports, may be a maximum of 2N. An example of calculating the number of MGIDs will be described below with reference to FIG. 5.

Subsequently, the multicast service filter rule transformation apparatus generates a multicast egress port matching each filter rule in the multicast SF table (130).

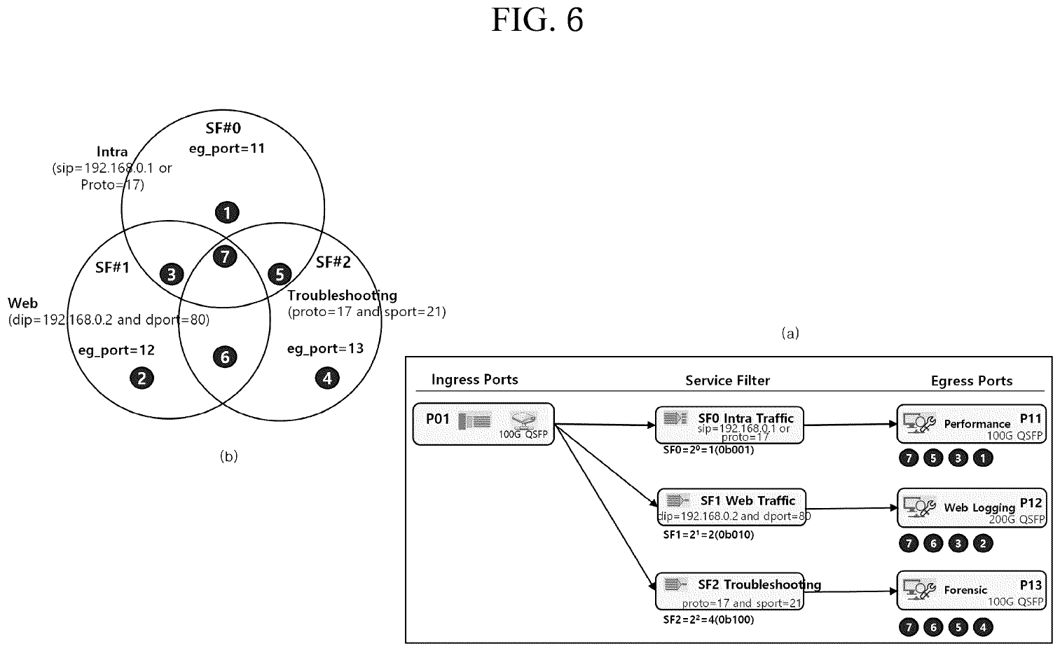

In the generating of the multicast egress port (130), the multicast service filter rule transformation apparatus may can generate a matching multicast egress port by performing a bitwise OR operation on each value of the egress label. An example of this will be described below with reference to FIG. 6.

FIG. 2 is a diagram illustrating the concept of transformation from unicast service flow rules into multicast service flow rules according to an embodiment of the present invention.

Referring to FIG. 2, a unicast filter table 21 is composed of one filter table, as indicated by reference numeral 210. Each rule entry constituting the one filter table is matched to set up unicast output for a service flow to each egress port 11, 12, 13. In the unicast filter table 21, ingress port, rule ID, SIP, DIP, proto, sport, dport are matching key value fields, and egress port is matching process data.

In a method of processing a service flow using the unicast filter table 21, when matching of a predetermined rule entry is performed, a result is immediately returned, without performing rule matching of the remaining sub-entries, to perform unicast transmission, which is one action corresponding to the conditions of the pertinent rule matching. Examples of unicast filter tables 21 include access control list (ACL), a black list (BL), and the like.

In addition, the method of processing a service flow using the unicast filter table 21 requires multiple duplicate rule entries for each ingress port according to a BD to decide the rule filter and an egress port for the ingress port.

In comparison, a multicast service filter table 22 is set to multicast the service flow to egress ports 11, 12, 13, respectively, for each filter rule entry matching.

The multicast service filter rule transformation apparatus according to an embodiment divides the rule entries constituting the unicast filter table 21 and transforms the unicast filter table 21 into a plurality of SF tables 22. Consequently, a plurality of rule entries may match each SF. For example, as indicated by reference numeral 222, three SF tables 22 may be configured with two and one rule entries. Specifically, with SF table IDs (SF 0, SF 1, SF 2), SF 0 is composed of two rule entries, and SF 1 and SF 2 are each composed of one rule entry.

Since SF table IDs are matched with egress ports, rule entries from the unicast filter table 21 whose output is designated to the same egress port are registered as additional rule entries within the same SF table 22.

The multicast service filter rule transformation apparatus may calculate a value of the SF table by processing a value N of SF table ID as 2N. For example, the value of SF table for SF0 is 2⁰=(0b001), for SF1, it is 2¹=2 (0b010), and for SF2, it is 2²=4 (0b100).

The multicast service filter rule transformation apparatus may set an ingress label for each ingress port according to the BD connected to the SF table and the egress port. Here, the ingress port is a matching key value field, and the ingress label is matching process data. For example, as indicated by reference numeral 221, ingress port P01 is connected to SF0(2⁰=1) and SF1(2¹=2) through BD, so the ingress label is 2⁰+2¹=3 (0b011). Similarly, ingress port P02 is connected to SF0(2⁰=1) and SF1(2¹=2) through BD, resulting in an ingress label of 2⁰+2¹=3 (0b011). Ingress ports P01 and P02 have the filter rules of SF0 and SF1 tables applied.

Ingress port P03 is connected to SF0(2⁰=1), SF1(2¹=2), and SF2(2²=4) through BD, resulting in an ingress label of 2⁰+2¹+2²=7 (0b111). Ingress port P03 has the filter rules of all SF0, SF1, and SF2 tables applied.

That is, ingress port P01 has the rules of SF0 and SF1 tables applied, ingress port P02 has the rules of SF1 and SF2 tables applied, and ingress port P03 has the rules of SF0, SF1, and SF2 tables applied. As such, each ingress port has the filter rules of the corresponding multicast SF table applied, and the filter rules of unmatched multicast SF tables are not applied. Therefore, based on the multicast SF table, the ingress port may be selectively applied to a filter rule of the matching multicast SF table.

The multicast service filter rule transformation apparatus generates an egress label that match the ingress label of the SF table 22. Here, the ingress label is a matching key value field, and the egress label is the matching process data. For example, as indicated by reference numeral 223, the egress labels are generated. The egress label matches the MGID.

Subsequently, the multicast service filter rule transformation apparatus performs a bitwise OR operation on each value of the egress label to generate the multicast egress port that match the bitwise OR-ed output port label. Here, the egress label is a matching key value field, and the multicast egress port is matching process data. For example, as indicated by reference numeral 224, the multicast service filter rule transformation apparatus outputs multicast egress ports.

For example, egress label 0b001(=1) matches egress port 11, egress label 0b010(=2) matches egress port P12, and egress label 0b100(=4) matches egress port P13.

In this case, egress label 0b011(=3) is the result of bitwise OR operation on egress labels 0b001(=1) and 0b010(=2), so it matches egress ports P11 and P12. Egress label 0b101(=5) is the result of bitwise OR operation on egress labels 0b001(=1) and 0b100(=4), so it matches egress ports P11 and P13. Egress label 0b110(=6) is the result of bitwise OR operation on egress labels 0b010(=2) and 0b100(=4), so it matches egress ports P12 and P13. Egress label 0b111(=7) is the result of bitwise OR operation on egress labels 0b001(=1), 0b010(=2), and 0b100(=4), so it matches egress ports P11, P12, and P13.

The multicast service filter rule transformation apparatus, for example, may be applied to the Intel Tofino1 Architecture ASIC, but it is not limited thereto.

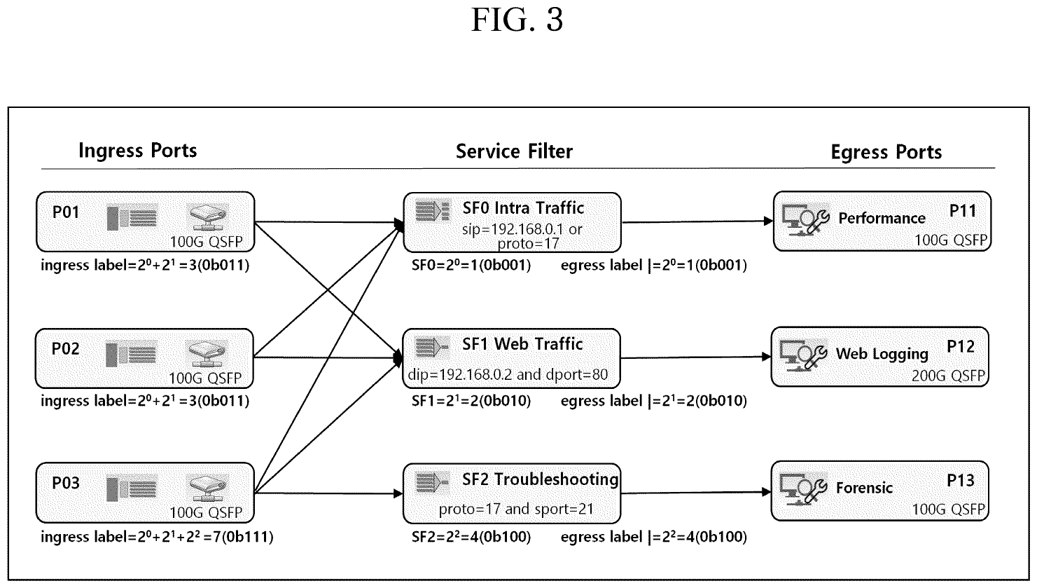

FIG. 3 is a diagram illustrating BD for generating an ingress label according to an embodiment of the present invention.

Referring to FIG. 3, the multicast service filter rule transformation apparatus generates an ingress label by matching filter combinations each ingress port connected to the SF table and BD.

As shown in FIG. 3, ingress port P01 is connected to service filter SF0 and egress port P11, and connected to service filter SF1 and egress port P12.

Ingress port P02 is also connected to service filter SF0 and egress port P11, and connected to service filter SF1 and output port P12.

Ingress port P03 is also connected to service filter SF0 and egress port P11, and connected to service filter SF1 and egress port P12, as well as to service filter SF2 and egress port P13.

The ingress label is set for each ingress port according to the BD connected to the SF table and the egress port. In this case, the multicast service filter rule transformation apparatus calculates a value of the ingress label by performing a bitwise OR operation on values of the SF tables connected to the ingress port. For example, ingress port P01 is connected to SF0(2⁰=1) and SF1(2¹=2) through BD, resulting in an ingress label value of 2⁰+2¹=3(0b011). Similarly, ingress port P02 is connected to SF0(2⁰=1) and SF1(2¹=2) through BD, resulting in an ingress label value of 2⁰+2¹=3(0b011). Ingress port P03 is connected to SF0(2⁰=1), SF1(2¹=2), and SF2(2²=4) through BD, resulting in an ingress label value of 2⁰+2¹+2²=7(0b111).

Ingress ports P01 and P02 are connected to SF0 (egress port P11) and SF2 (egress port P12) only through BD, and thus are applied only filter rules of SF0 and SF1 tables.

Ingress port P03 is connected to SF0 (egress port P11), SF1 (egress port P12), and SF3 (egress port P13) through BD, and thus are applied filter rules of all SF tables, including SF0, SF1, and SF2.

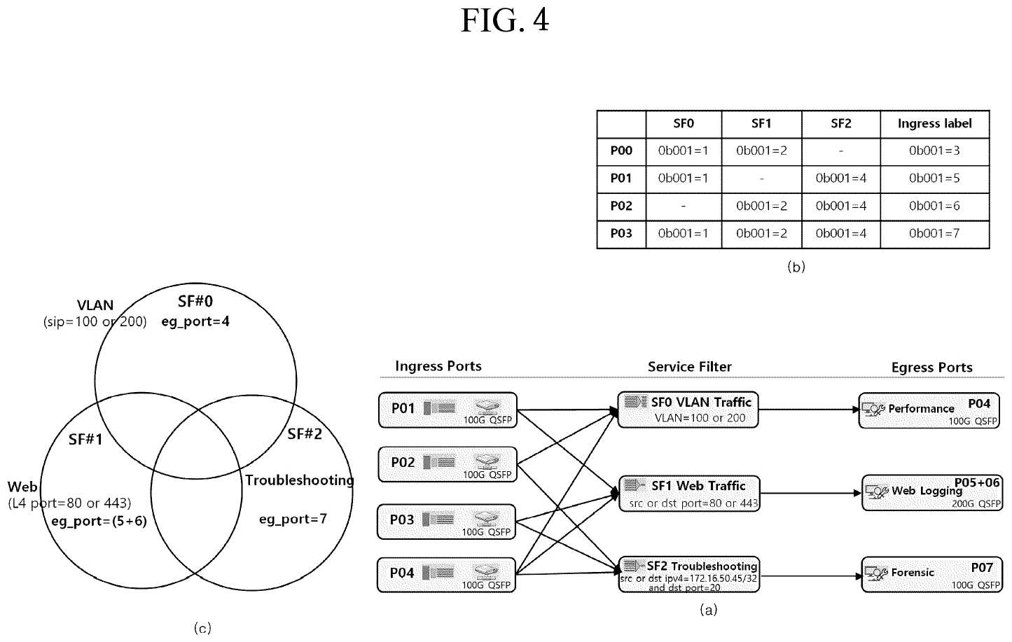

FIG. 4 is a diagram illustrating BD for generating an ingress label according to another embodiment of the present invention.

Specifically, (a) depicts the connection between ingress ports, SFs, and egress ports through BD, (b) illustrates an example of setting an ingress label, and (c) illustrates the set relationship among SFs in a Venn diagram.

Referring to FIG. 4, the multicast service filter rule transformation apparatus calculates a value of the ingress label by performing a bitwise OR operation on values of the multicast SF tables connected to the ingress port. For example, ingress port P00 is connected to SF0(2⁰=1) and SF1(2¹=2) through BD, resulting in an ingress label value of 2⁰+2¹=3(0b011). Ingress port P01 is connected to SF0(2⁰=1) and SF2(2²=4) through BD, resulting in an ingress label value of 2⁰+2²=5(0b101). Ingress port P02 is connected to SF1(2¹=2) and SF2(2²=4) through BD, resulting in an ingress label value of 2¹+2²=6(0b110). Ingress port P03 is connected to SF0(2⁰=1), SF1(2¹=2), and SF2(2²=4) through BD, resulting in an ingress label value of 2⁰+2¹+2²=7(0b111).

FIG. 5 is a diagram illustrating an example of calculating the number of MGIDs according to an embodiment of the present invention.

Referring to FIG. 5, the multicast service filter rule transformation apparatus calculates the number of MGIDs and the number of egress ports by performing an intersection operation algorithm between SFs.

The number of MGIDs is determined by the number of cases of multicast based on N egress ports. Here, the maximum number of MGIDs is 2N. The number of SF tables aligns with the total number of egress ports. In other words, N represents the number of SF IDs.

If there are three egress ports, there will be three SF tables, resulting in 2³=8(0 to 7) possible multicast paths.

At this time, the egress ports are 11, 12, and 13, totaling three.

The egress labels are 3-bit labels, including {0b000 to 0b111}.

The MGIDs are 0, 1, 2, 3, 4, 5, 6, and 7, totaling 2³=8.

In the Intel Tofino1 Architecture, MGIDs can be supported with a maximum of 2 bytes, providing 2¹⁶=65,536 (0 to 65535) possible cases. Therefore, up to 16 SF tables (with IDs from 0 to 15) may be accommodated.

Referring to FIG. 5, MGID 1 matches egress port 11, MGID 2 matches egress port P12, MGID 3 matches egress ports P11 and P12, MGID 4 matches egress port P13, MGID 5 matches egress ports P11 and P13, MGID 6 matches egress ports P12 and P13, and MGID 7 matches egress ports P11, P12, and P13.

FIG. 6 is a diagram illustrating an example of multicast output using a multicast service filter table according to an embodiment of the present invention.

Specifically, (a) shows the connection between an ingress port, SFs, and egress ports through BD, and (b) illustrates the set relationship among SFs in a Venn diagram.

Referring to FIG. 6, the multicast service filter rule transformation apparatus generates multicast an egress port that matches each filter rule of the SF table.

When the ingress port is P01, the egress port matching MGID 1 is P11 (\textcircled{1}), MGID 2 matches egress port P12 (\textcircled{2}), MGID 3 matches egress ports P11, P12 (\textcircled{3}), MGID 4 matches egress port P13 (\textcircled{4}), MGID 5 matches egress ports P11, P13 (\textcircled{5}), MGID 6 matches egress ports P12, P13 (\textcircled{6}), and MGID 7 matches egress ports P11, P12, P13 (\textcircled{7}).

Multicast service filter SF 0 matches egress port P11, SF 1 matches egress port P12, and SF 2 matches egress port P13.

Therefore, egress port P11 matches MGIDs 7, 5, 3, and 1 (\textcircled{7}, \textcircled{5}, \textcircled{3}, and \textcircled{1}).

Egress port P12 matches MGIDs 7, 6, 3, and 2 (\textcircled{7}, \textcircled{6}, \textcircled{3}, and \textcircled{2}).

Egress port P13 matches MGIDs 7, 6, 5, and 4 (\textcircled{7}, \textcircled{6}, \textcircled{3}, and \textcircled{2}).

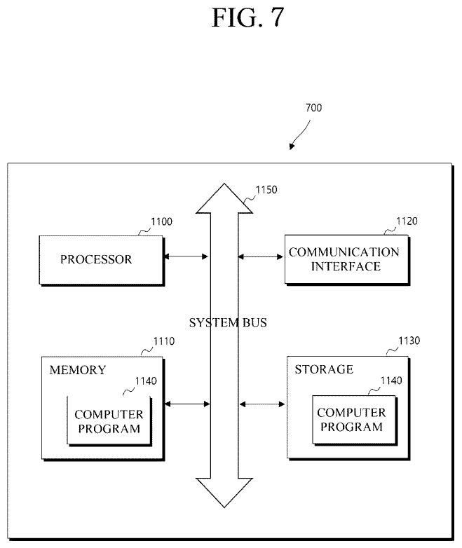

FIG. 7 is a diagram illustrating the hardware configuration of a multicast service filter rule transformation apparatus according to an embodiment of the present invention.

Referring to FIG. 7, a multicast service filter rule transformation apparatus 700 may include at least one processor 1100, a memory 1110 configured to load a computer program 1140 executed by the processor 1100, a communication interface 1120, a storage 1130 configured to store the computer program 1140 executed by the processor 1100, and a system bus 1150.

The processor 1100 controls the overall operation of the components of the multicast service filter rule transformation apparatus 700. The processor 1100 may perform computations related to at least one application or program to execute the methods/operations according to various embodiments of this disclosure.

The memory 1110 stores various data, commands, and/or information. The memory 1110 may load one or more computer programs 1140 from the storage 1130 to execute the methods/operations according to various embodiments of this disclosure.

The storage 1130 may non-temporarily store one or more computer programs 1140. The computer program 1140 may include one or more instructions implementing the methods/operations according to various embodiments of this disclosure.

Once the computer program 1140 is loaded into the memory 1110, the processor 1100 may perform the method/operations according to various embodiments of this disclosure by executing one or more instructions.

The system bus 1150 provides communication functionality among the components of the multicast service filter rule transformation apparatus 700. The communication interface 1120 supports Internet communication for the multicast service filter rule transformation apparatus 700.

According to the multicast service filter rule transformation method and apparatus of the present invention, a unicast filter table for unicast transmission may be transformed into a multicast service filter table for multicast transmission.

Heretofore, the present invention has been described by focusing on the exemplary embodiments. It can be understood by those skilled in the art to which the present invention pertains that the present invention can be implemented in modified forms without departing from the essential feature of the present invention. Therefore, the disclosed embodiments should be considered as illustrative rather than determinative. The scope of the present invention is defined by the appended claims rather than by the foregoing description, and all differences within the scope of equivalents thereof should be construed as being included in the present invention.

What is claimed is:

1. A multicast service filter rule transformation method comprising:
receiving a unicast filter table;
transforming the received unicast filter table into a plurality of multicast service filter tables by dividing rule entries of the unicast filter table; and
generating a multicast egress port that matches each filter rule in the multicast service filter tables.

2. The multicast service filter rule transformation method of claim 1, wherein the transforming into the multicast service filter tables comprises:
setting a service filter table ID by dividing the rule entries constituting the unicast filter table into the plurality of multicast service filter tables;
setting an ingress label for each ingress port in the multicast service filter tables according to a bridge domain connected to the multicast service filter table and an egress port; and
generating an egress label that matches the ingress label.

3. The multicast service filter rule transformation method of claim 2, wherein the setting of the ingress label comprises
calculating a value of the multicast service filter table using a value N of the service filter table ID; and
calculating a value of the ingress label using values of multicast service filter tables connected to the ingress port.

4. The multicast service filter rule transformation method of claim 3, wherein in the calculating of the value of the multicast service filter table, the value N of the service filter table ID is processed as 2N to calculate the value of the multicast service filter table.

5. The multicast service filter rule transformation method of claim 3, wherein in the calculating of the value of the ingress label, the value of the ingress label is calculated by performing a bitwise OR operation on the values of the multicast service filter tables connected to the ingress port.

6. The multicast service filter rule transformation method of claim 2, wherein in the generating of the egress label, the number of multicast egress port group IDs (multicast group IDs, hereinafter referred to as “MGIDs”) is calculated by performing an intersection operation algorithm on service filters, the number of SF tables aligns with the total number N of egress ports, and the number of MGIDs, which is determined by the number of cases of multicast based on N egress ports, is a maximum of 2N.

7. The multicast service filter rule transformation method of claim 1, wherein in the generating of the multicast egress port, a bitwise OR operation is performed on each value of the egress label to generate the multicast egress port that matches the bitwise OR-ed egress label.

8. The multicast service filter rule transformation method of claim 1, further comprising selectively applying an ingress port to the filter rule in the multicast service filter table matching the ingress port based on the multicast service filter table.

9. A multicast service filter rule transformation apparatus comprising:
a processor; and
a memory configured to load a computer program executed by the processor,
wherein the processor receives a unicast filter table, transforms the received unicast filter table into a plurality of multicast service filter tables by dividing rules entries of the unicast filter table, and generates a multicast egress port that matches each filter rule in the multicast service filter tables.
